(19) United States
(12) Patent Application Publication
(10) Pub. No.: US 2001/0000283 A1
(43) Pub. Date: Apr. 19, 2001

(54) Apparatus comprising at least two transport carts and a collection station

(76) Inventors: Herbert Eberlein, Bubesheim (DE); Rainer Eckert, Kirchheim (DE); Jurgen Hammerle, Guneburg (DE)

Correspondence Address: BURNS DOANE SWECKER & MATHIS L L P, POST OFFICE BOX 1404, ALEXANDRIA, VA, 22313-1404, US

(21) Appl. No.: 09/727,682

(22) Filed: Dec. 4, 2000

(30) Foreign Application Priority Data
Apr. 3, 1999 (DE) 199 15 316.7

(51) Int. Cl. B62D 51/04

(52) U.S. Cl. 180/19.1; 414/; 180/65.1

(57) ABSTRACT

An apparatus (1) includes at least two transport carts (2) and a collection station (15) intended for holding the transport carts (2), whereby the transport carts (2) are provided with a manually operated shunting device (4) and are designed so that they can be pushed inside other transport carts (2) in a space-saving manner, and whereby the collection station (15) has guides (18) in which the transport carts (2) can be stored aligned in at least one row (22) and can be removed from this row (22) again. The collection station (15) is provided with at least one longitudinally extending arrangement (19) designed to transfer energy, which extends parallel to the guides (18), and that each transport cart (2) is provided with a receiving device (9) for receiving the transmitted energy.

### CROSS-REFERENCE TO RELATED APPLICATIONS

1. The present application claims priority of German Patent Application No. 199 15 316.7, filed on Apr. 3, 1999 and International Application No. PCT/DE00/00994, filed on Mar. 30, 2000. The contents of both applications are incorporated herein by reference. In addition, the present application is a continuation of International Application No. PCT/DE00/00994, which designated the United States of America.

### BACKGROUND OF THE INVENTION

2. 1. Field of the Invention

3. The present invention relates to an apparatus comprising at least two transport carts and a collection station intended for holding the transport carts, and in particular to an apparatus wherein the transport carts are provided with a manually operated shunting device and are designed so that they can be pushed inside other transport carts in a space-saving manner, and whereby the collection station has guides in which the transport carts can be stored aligned in at least one row and can be removed from the row again.

4. 2. Description of Related Art

5. In the past, suggestions have been made to provide transport carts with a power source. This makes it possible to drive transport carts with an electric drive, which can be driven at walking speed. A power source on transport carts also can be used to supply information devices, for example a display, with electricity. Since the power source is usually at least one battery, it must be recharged now and then.

### OBJECTS AND SUMMARY

6. It is an object of the present invention to further develop an apparatus of this type so that a transfer of energy to the transport carts can be accomplished in a simple and practical manner when the transport carts are within the collection station.

7. The objective can be realized by providing the collection station with at least one longitudinally extending arrangement designed to transfer energy, which arrangement extends parallel to the guides, and by providing each transport cart with a receptacle device for receiving the transmitted energy.

8. One embodiment of the present invention advantageously utilizes the fact that the transport carts within the collection station are aligned in a row by guides. And, the arrangement intended for transmitting the energy can be arranged parallel to the guides. In this way, a greater dimensional accuracy is achieved for performing the energy transmission, for example, inductively or with wiper contacts.

9. In one exemplary embodiment of the present invention, the receiving device for the transmitted energy is arranged always at the same place on the transport cart in the area of the stacking dead space of the transport cart. As a result, exciter coils that act inductively on the receiver coils that form the receiving devices on the transport carts can be provided at regular intervals on the arrangement for transmitting the energy. The receiving devices are arranged on one of two rear lateral areas of the transport carts.

10. In a second exemplary embodiment, the transport carts are provided with a running wheel located on a frame in the center between four casters, and the running wheel has a directionally stabilizing effect when the transport cart is moved. The running wheel is guided inside a guide that is arranged on the bottom inside a collection station, whereby the arrangement for transmitting energy is arranged very close to the guide and extends parallel to it, and whereby the arrangement has two longitudinally extending wiper contacts that act as plus and minus poles and whereby cooperating contacts, located close to the running wheel, are in contact with these two wiper contacts.

11. The arrangement is preferably permanently under current so that the power source of the transport carts is always automatically charged when the carts are in the collection station.

### BRIEF DESCRIPTION OF THE DRAWINGS

12. The present invention is explained in more detail in reference to exemplary embodiments, whereby:

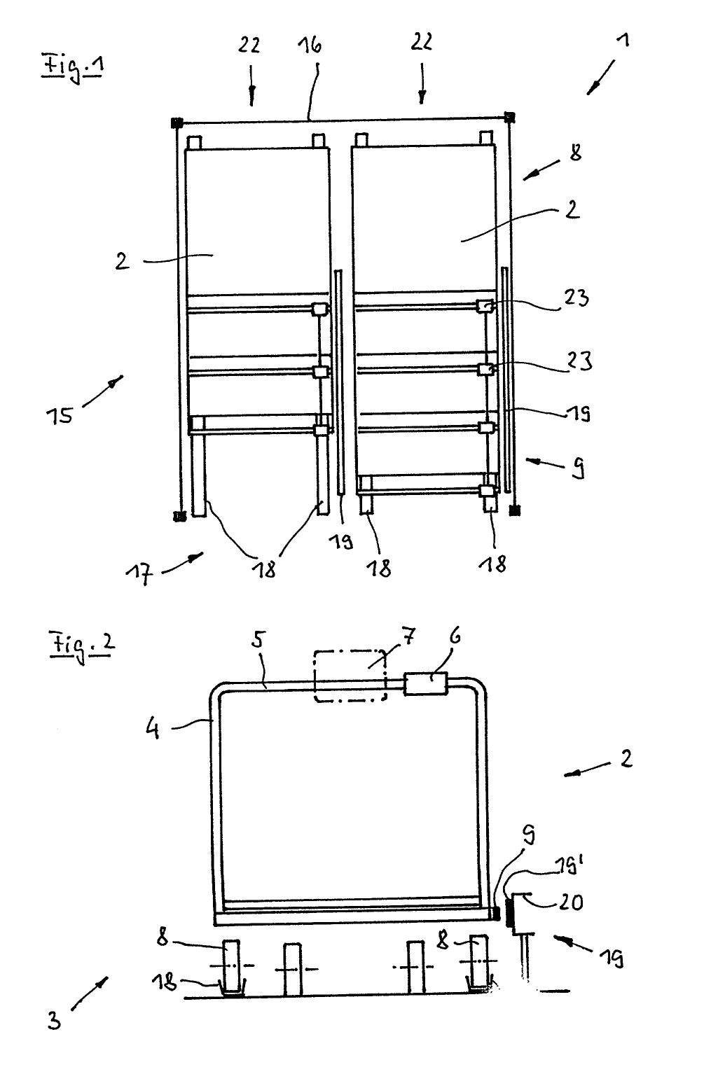

13. FIG. 1 is a top view of a collection station with two rows of stored carts;

14. FIG. 2 is a view of a transport cart with a shunting device;

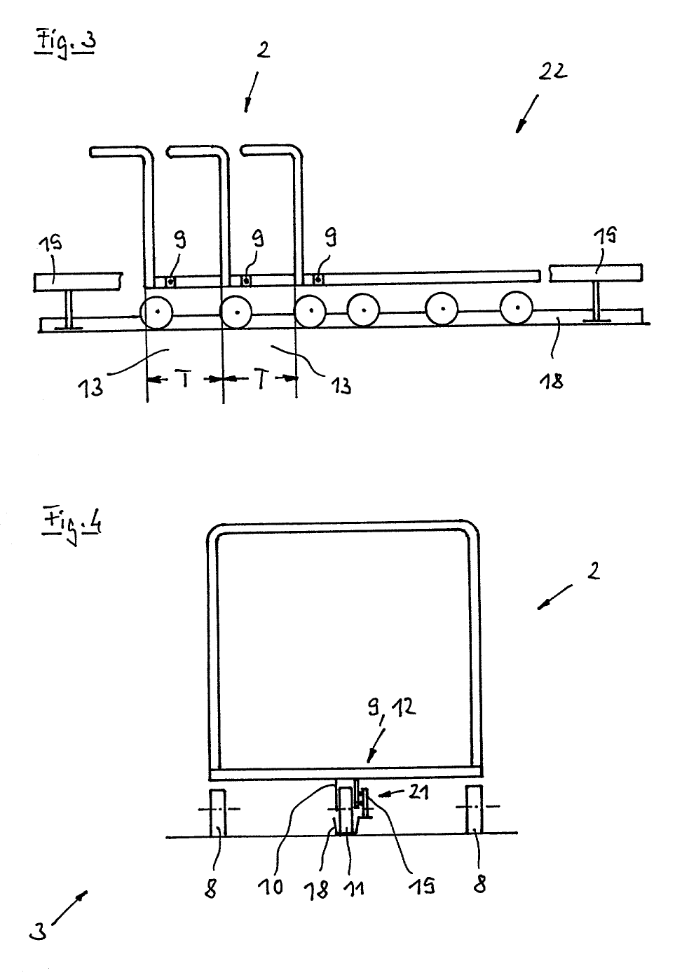

15. FIG. 3 is a view of a row of transport carts pushed inside one another, and,

16. FIG. 4 is a view of another embodiment of a transport cart.

### DETAILED DESCRIPTION OF THE PREFERRED EMBODIMENTS

17. FIG. 1 is a top view and a schematic portrayal of an apparatus 1 comprising at least two transport carts 2 and a collection station 15, in which the transport carts 2 are stored in two rows 22. The collection station 15 is preferably a shed-like structure with a roof supported by three walls.

18. In a preferred embodiment, the transport carts 2 are stored with the help of deposit locks 23 so as to be connected with one another. By paying a deposit, a transport cart 2 can be removed from a row 22. When the transport cart 2 is returned, it is again connected to this row 22, and the user receives back his deposit.

19. At the bottom of the collection station 15, guides 18 are provided that extend from the open entrance 17 towards the back wall 16 of the collection station 15. The transport carts 2 are designed in a known manner so that they can be pushed inside other identical transport carts 2 in a space-saving manner. The transport carts 2 are guided preferably with their wheels or casters 8 inside the guides 18. This causes the transport carts 2 to be aligned accurately in one direction. Each row 22 of transport carts 2, is provided with one arrangement 19 that is designed to transmit energy, whereby each arrangement 19 extends longitudinally to the row 22, parallel to the guides 18.

20. Each transport cart 2 is provided with a receiving device 9 that is intended to receive energy transmitted by the arrangement 19. See FIG. 2. FIG. 2 is a view of the back side 3 of a transport cart 2.

21. A shunting device 4 is located at the back side of the cart 2. The shunting device 4 comprises a push and/or steering device 5. The transport cart 2 may include an electric motor drive unit. In this case, the shunting device 4 also includes control elements 6 that can be used to control and influence the electric motor drive unit. In the same manner, an electronic information device 7, for example an electrical display, can be provided at or near the shunting device 4.

22. The transport cart 2 is preferably designed so that it can be used to transport goods in self-service shops or luggage for travelers. The two rear wheels or casters 8 of the transport cart 2 are designed so as to fit within the guides 18.

23. At the right side of the wheelbase of the transport cart 2, a receiving device 9 is located. From the receiving device 9, a power-carrying cable leads to a power source (not shown here), preferably a battery, on the transport cart 2. Electrically acting exciter coils 19′ are arranged at regular intervals on the arrangement 19. The exciter coils create with alternating current a pulsating magnetic field that acts on the receiving device 9, which includes a receiving coil. The exciter coils transmit energy, in the form of an electrical current, to the receiving coils, which transfer the power to the power source on the transport cart 2. In the example, energy is transmitted inductively from the exciter coils to the receiving coils. The arrangement 19 in the example has a longitudinally extending, horizontally arranged, bar-supported rail 20 on which the exciter coils 19′ are arranged.

24. FIG. 3 is a side view of a row 22 of transport carts 2 pushed inside each other and guided in guides 18. In the figure, a portion of the arrangement 19 is broken away to illustrate the structure behind it. The receiving devices 9 on the transport carts 2 each are shown schematically in the form of a dot. The dimension T designates the portion of each cart that extends from the preceding cart, when the carts are stacked together. These portions are referred to as the stacking dead spaces 13 of the individual transport carts 2. Each receiving device 9 is located within a stacking dead space 13 so that the receiving device is not covered by part of the adjacent transport cart 2. The energy therefore can be transmitted by the arrangement 19 to the receiving devices 9 at any time. The exciter coils 19′ on the arrangement 19 are placed in accordance with intervals T.

25. FIG. 4 is also a view of the back 3 of a transport cart of an alternative embodiment, and shows a transport cart 2 that is provided between its four wheels 8 with a running wheel 11 that is provided on its frame 10, for example in such a way as described in European Patent No. 0 352 647. At least the center running wheel 11 is located in a guide 18. An arrangement 19 is provided on the guide 18 and extends parallel to it. In the example, this arrangement is formed by two current-bearing, low voltage rails 21, whereby one rail forms the plus pole, the other rail the minus pole. Near the running wheel 11 and at a suitable place in the frame 10, the receiving device 9 is provided in the form of a two-pole, spring-loaded wiper contact 12 that presses against the arrangement 19 so that the electrical energy can be transmitted.

26. When the transport carts 2 leave the collection station 15, the energy transmission is interrupted. This also applies to the exemplary embodiment in FIG. 2.

27. Although only preferred embodiments are specifically illustrated and described herein, it will be appreciated that many modifications and variations of the present invention are possible in light of the above teachings and within the purview of the appended claims without departing from the spirit and intended scope of the invention.

CLAIMS:

1. An apparatus, comprising:
at least two transport carts; and
a collection station intended for holding the transport carts;
whereby:
the transport carts are configured so that one of the transport carts can be pushed inside the other of the transport carts in a space-saving manner, wherein when the transport carts are pushed together, each cart has an exposed dead space that does not fit within a preceding one of the carts;
the collection station has guides through which the transport carts can be stored aligned in at least one row in the collection station and can be removed from this row again;
the collection station has at least one longitudinally extending arrangement intended for energy transmission that extends parallel to the guides; and
a receiving device for receiving the transmitted energy is on each of the transport carts within the exposed stacking dead space of the transport cart, and the arrangement intended for transmitting energy is arranged next to the stored transport carts.

2. The apparatus as claimed in claim 1, wherein each receiving device is arranged in one of two rear lateral areas of the transport carts.

3. The apparatus as claimed in claim 1, wherein the arrangement is provided at regular intervals with exciter coils that are designed to create magnetic fields.

4. The apparatus as claimed in claim 2, wherein the arrangement is provided at regular intervals with exciter coils that are designed to create magnetic fields.

5. The apparatus as claimed in claim 3, wherein the exciter coils are arranged on a rail.

6. The apparatus as claimed in claim 4, wherein the exciter coils are arranged on a rail.

7. The apparatus as claimed in claim 1, wherein the transport carts stored in a row are connected with deposit locks.

8. The apparatus as claimed in claim 2, wherein the transport carts stored in a row are connected with deposit locks.

9. The apparatus as claimed in claim 3, wherein the transport carts stored in a row are connected with deposit locks.

10. The apparatus as claimed in claim 4, wherein the transport carts stored in a row are connected with deposit locks.

11. The apparatus as claimed in claim 5, wherein the transport carts stored in a row are connected with deposit locks.

12. The apparatus as claimed in claim 6, wherein the transport carts stored in a row are connected with deposit locks.

13. An apparatus, comprising:
at least two transport carts, each of the carts including a central running wheel; and
a collection station intended for holding the transport carts;
whereby:
the transport carts are configured so that one of the transport carts can be pushed inside the other of the transport carts in a space-saving manner;
the collection station has guides through which the transport carts can be stored aligned in at least one row in the collection station and can be removed from this row again;
the collection station has at least one longitudinally extending arrangement intended for energy transmission that extends parallel to the guides; and
a receiving device for receiving the transmitted energy is on each of the transport carts adjacent the central running wheel, and the arrangement intended for transmitting energy is arranged next to the stored transport carts.
